(19) United States
(12) Patent Application Publication
(10) Pub. No.: US 2009/0260023 A1
(43) Pub. Date: Oct. 15, 2009

(54) Multiplexing Reserved Ports

(75) Inventors: Arun Keshava Murthy, Santa Clara, CA (US); Chetan Aswathanarayana, Bangalore (IN); Neducheralathan Shanmugam, Bangalore (IN)

Correspondence Address: HEWLETT-PACKARD COMPANY;Intellectual Property Administration, 3404 E. Harmony Road, Mail Stop 35, FORT COLLINS, CO, 80528, US

(73) Assignee: Hewlett-Parckard Development Commpany, LP, Houston, TX (US)

(21) Appl. No.: 12/131,395

(22) Filed: Jun. 2, 2008

(30) Foreign Application Priority Data
Apr. 11, 2008 (IN) 919/CHE/2008

(51) Int. Cl. G06F 9/44

(52) U.S. Cl. 719/330

(57) ABSTRACT

Included are embodiments for multiplexing reserved ports. At least one embodiment of a method includes receiving (732) a request to communicate with a host (502) and determining (736) whether a mapping exists between the host (502) and a first remote procedure call (RPC) client handle (506). Some embodiments include in response to determining that a mapping does not exist between the host and the first RPC client handle, determining (740) a second RPC client handle (506) to establish a mapping, the established mapping facilitating RPC communication with the host.

### CROSS-REFERENCE TO RELATED APPLICATION

This application claims priority to Indian utility Application No. 919/CHE/2008, entitled “Multiplexing Reserved Ports,” filed Apr. 11, 2008, which is hereby incorporated by reference in its entirety.

### BACKGROUND

In an effort to maximize electronic security at a host device (such as a personal computer, a UNIX based machine, etc.), many remote procedure call (RPC) applications and kernel RPCs use reserved ports that are limited in number. More specifically, kernel RPCs and RPC applications may be configured to execute in one or more address spaces, such as another computer in a common network. In such a scenario, the kernel RPCs and/or RPC applications may communicate using the reserved ports such that the reserved ports are exhausted. When the reserved ports are exhausted, malfunction may occur.

### SUMMARY

Included are embodiments for multiplexing reserved ports. At least one embodiment of a method includes receiving a request to communicate with a host and determining whether a mapping exists between the host and a first remote procedure call (RPC) client handle. Some embodiments include, in response to determining that a mapping does not exist between the host and the RPC client handle, determining a second RPC client handle to establish a mapping, where the established mapping facilitates RPC communication with the host.

Also included are embodiments of a computer readable medium. At least one embodiment includes receiving logic configured to receive a request to communicate with a host; and first determining logic configured to determine whether a mapping exists between the host and a first remote procedure call (RPC) client handle. Some embodiments include second determining logic configured, in response to determining that a mapping does not exist between the host and the RPC client handle, to determine a second RPC client handle to establish a mapping, wherein the established mapping facilitates RPC communication with the host.

Also included are embodiments of a system. At least one embodiment includes means for receiving a request to communicate with a host and means for determining whether a mapping exists between the host and a first remote procedure call (RPC) client handle. Some embodiments include means for, in response to determining that a mapping does not exist between the host and the RPC client handle, determining a second RPC client handle to establish a mapping, wherein the established mapping facilitates RPC communication with the host.

Other embodiments and/or advantages of this disclosure will be or may become apparent to one with skill in the art upon examination of the following drawings and detailed description. It is intended that all such additional systems, methods, features, and advantages be included within this description and be within the scope of the present disclosure.

### BRIEF DESCRIPTION

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views. While several embodiments are described in connection with these drawings, there is no intent to limit the disclosure to the embodiment or embodiments disclosed herein. On the contrary, the intent is to cover all alternatives, modifications, and equivalents.

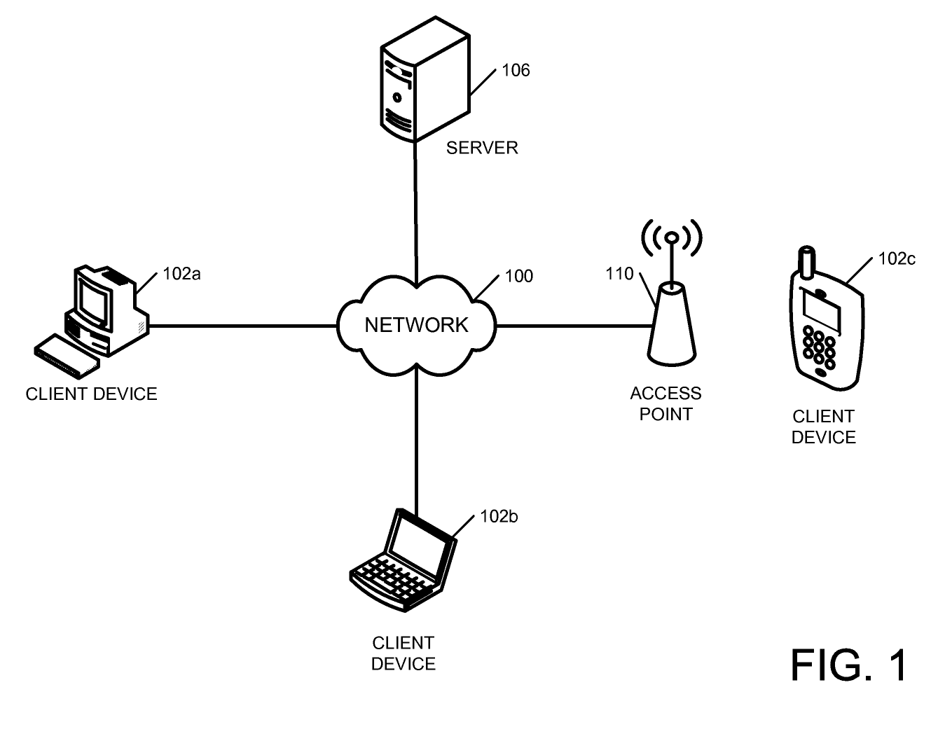

FIG. 1 depicts a network diagram illustrating an exemplary embodiment for communicating data with a client device.

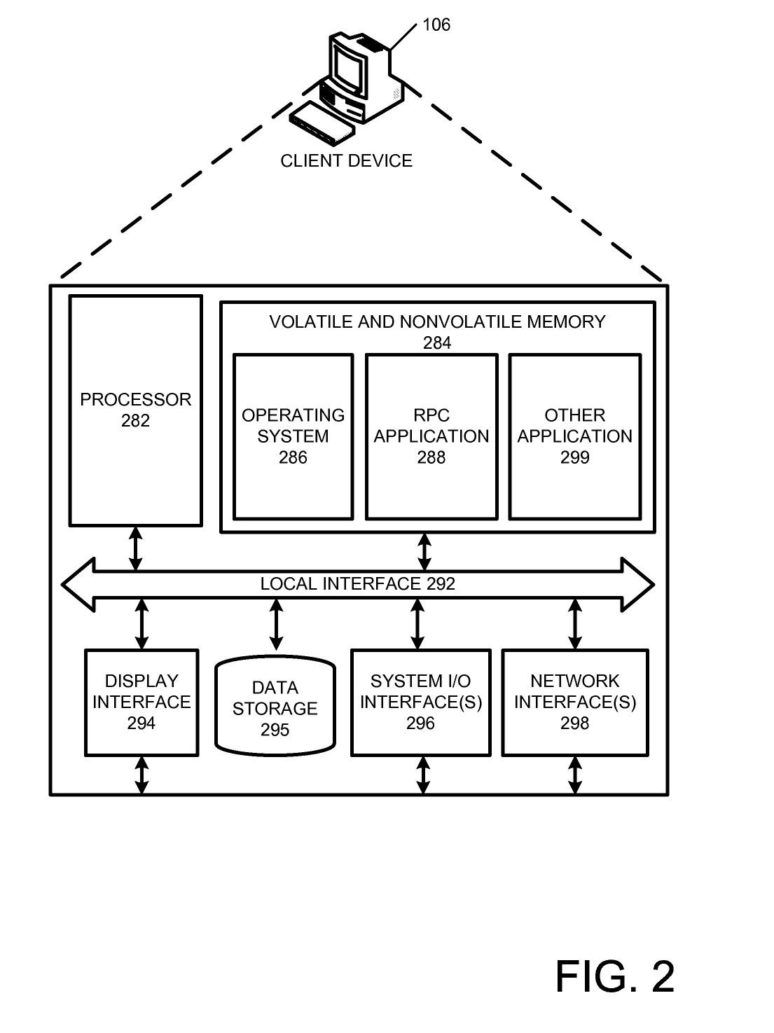

FIG. 2 depicts a block diagram illustrating an exemplary embodiment of a client device, such as the client device from FIG. 1.

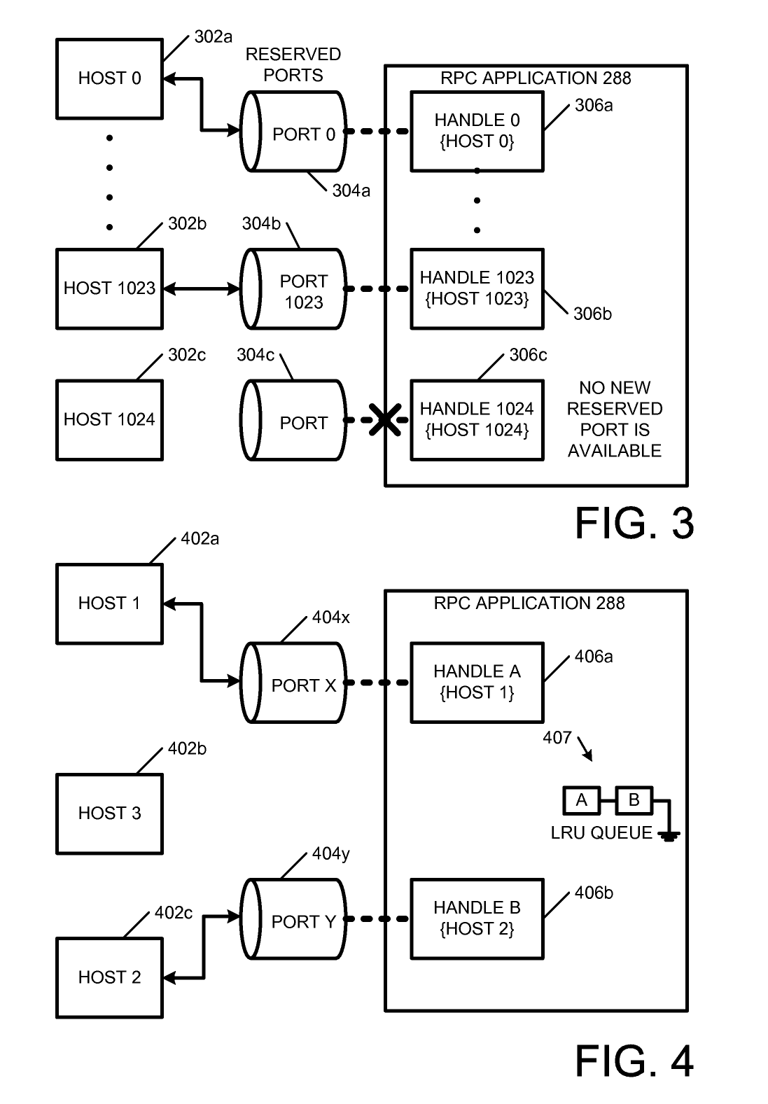

FIG. 3 depicts a block diagram, illustrating an exemplary embodiment of an application that may be configured to communicate with one or more hosts, such as in the network configuration from FIG. 1.

FIG. 4 depicts a block diagram of an exemplary embodiment of an RPC application, utilizing a pool of network ports, similar to the diagram from FIG. 3.

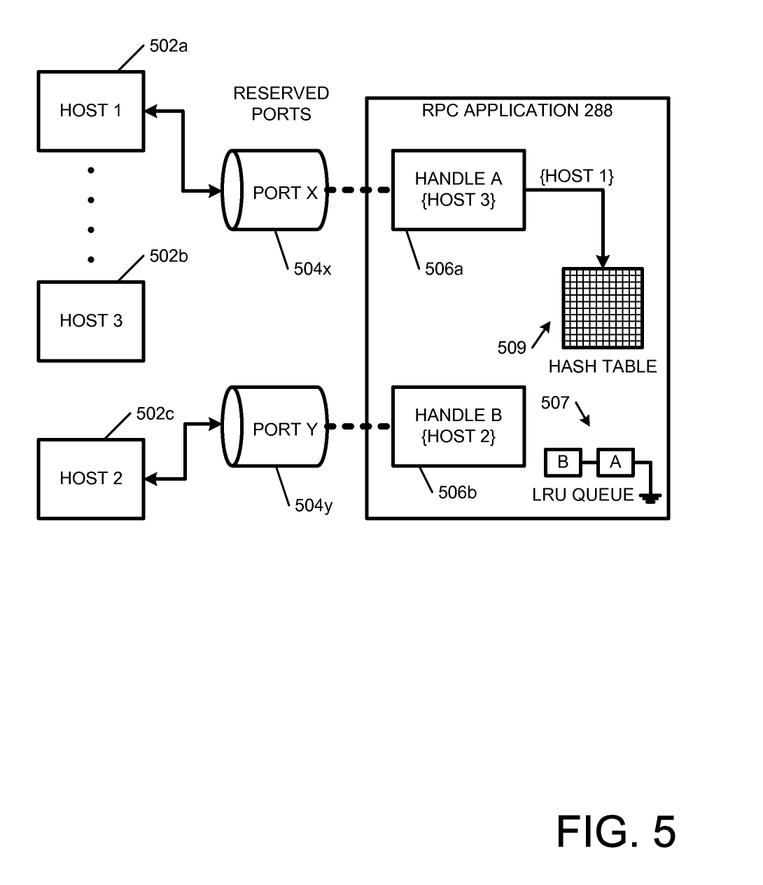

FIG. 5 depicts a block diagram of an exemplary embodiment of an RPC application utilizing a hash table to communicate with one or more hosts, similar to the diagram from FIG. 4.

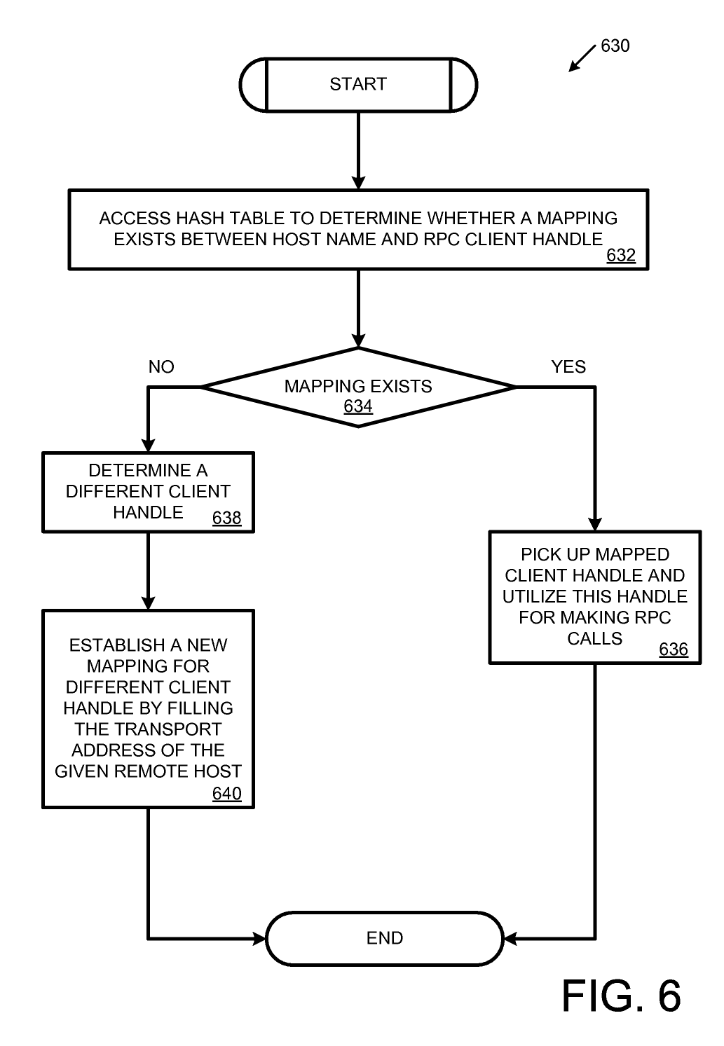

FIG. 6 depicts a flowchart illustrating an exemplary embodiment of a process that may be utilized for communicating with at least one host, such as in the diagram from FIG. 5.

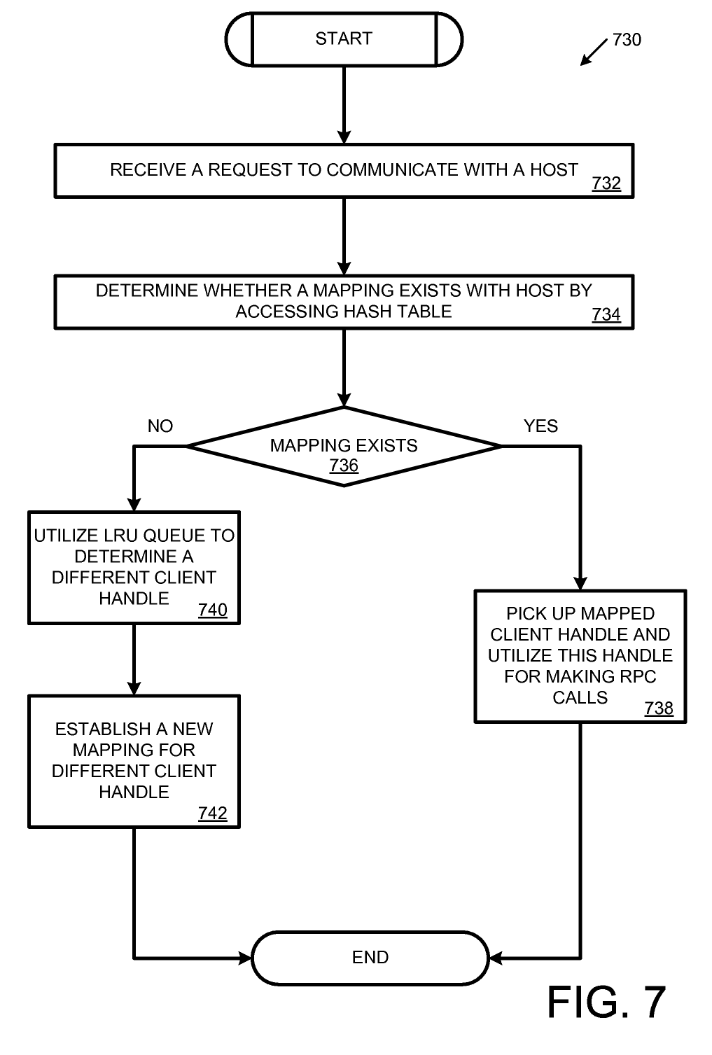

FIG. 7 depicts a flowchart of an exemplary embodiment of a process that may be utilized for determining whether a mapping exists with a remote host 502, similar to the flowchart from FIG. 6.

### DETAILED DESCRIPTION

Many RPC applications may be configured to create an RPC client handle that enables the RPC application to send and receive requests (e.g., RPC transactions). An RPC client handle is a structure that stores the transport address (IP address/UDP Port) information of a remote client. Apart from transport address, the RPC client handle may also contain an XTI end point (file descriptor) which is bound to the underlying transport address. So for contacting each and every remote client, RPC application creates a client handle. That is, there exists a 1-to-1 mapping between the remote client's name and the RPC client handle.

As a nonlimiting example, if an RPC application contacts one hundred (100) different remote clients, the RPC client may use one hundred (100) different client handles, effectively consuming one hundred (100) reserved ports. It should be noted that the RPC client handles, created by an RPC application, may have their x/open transport interface (XTI) endpoints bound to the non-reserved ports. When the number of RPC transactions exceeds the fixed (e.g., 1024) number of reserved user datagram protocol (UDP) ports, the system runs out of available reserved UDP ports and because of this, many applications using reserved ports may stop working properly.

Many of the asynchronous RPC applications on UDP transport may be configured to use reserved ports for security reasons. These ports may remain blocked for the entire duration of a transmission. When the number of RPC transactions exceeds the fixed (e.g., 1024) number of reserved UDP ports, the system may run out of available reserved UDP ports. Because of this, many application using reserved ports stop working properly.

Included in this disclosure are embodiments of a mechanism to limit and/or set a number of reserved ports that can be used by RPC applications during asynchronous transactions using UDP. Some embodiments may be configured to have a pool of reserved ports dedicated for an RPC application to use and all those ports may be shared for network transactions. The allotted reserved ports may be re-used by applications using one-to-many mapping between the reserved ports and RPC Transactions.

Referring to the drawings, FIG. 1 depicts a network diagram illustrating an exemplary embodiment for communicating data with a client device 102. More specifically, as illustrated in the nonlimiting example of FIG. 1, a network 100 may be utilized and may include a wide area network (WAN), such as the Internet, a public switched telephone network (PSTN), a mobile communications network (MCN) and/or other network. Similarly, the network 100 may include a wireline and/or a wireless local area network (LAN). Regardless of the communications medium and protocol, the network 100 may be coupled to one or more client devices 102a, 102b, 102c. The client devices 102a, 102b, 102c (collectively referred to as client device 102) may include a personal computer, laptop, and/or other device that is configured for communicating with the network 100. While the client devices 102a, 102b may be wireline devices, the client device 102c may be configured for wireless communications and be configured to communicate with the network 100 via an access point 110 or other wireless communications devices.

Additionally included in the nonlimiting example of FIG. 1, is the access point 110. The access point 110 may be configured as a wireless cellular tower, a wireless fidelity (WIFI) hotspot, a worldwide interoperability for microwave access (WIMAX) tower, and/or other wireless node.

Also included in the nonlimiting example of FIG. 1 is a server 106. The server 106 may be configured to facilitate the communication of electronic messages, which may include email, instant messages, short message service (SMS) messages audio messages, video messages, and/or other electronic messages. In some embodiments, the server 106 may be configured to provide messaging services to an account associated with the client device 102a. Similarly, in some embodiments, the server 106 may be configured to provide messaging services to one or more accounts associated with host devices 102b and 102c.

FIG. 2 depicts a block diagram illustrating an exemplary embodiment of a client device 102, such as the client device from FIG. 1. Although a wire-line device (e.g., the client device 102a) is illustrated, this discussion can be applied to wireless devices, as well. According to exemplary embodiments, in terms of hardware architecture, the client device 102 includes a processor 282, a memory component 284, a display interface 294, data storage 295, one or more input and/or output (I/O) device interface(s) 296, and/or one or more network interfaces 298 that are communicatively coupled via a local interface 292. The local interface 292 can include, for example but not limited to, one or more buses and/or other wired or wireless connections. The local interface 292 may have additional elements, which are omitted for simplicity, such as controllers, buffers (caches), drivers, repeaters, and receivers to enable communications.

Further, the local interface 292 may include address, control, and/or data connections to enable appropriate communications among the aforementioned components. The processor 282 may be a device for executing software, particularly software stored in the memory component 284. The processor 282 can include any custom made or commercially available processor, a central processing unit (CPU), an auxiliary processor among several processors associated with the client device 102, a semiconductor based microprocessor (in the form of a microchip or chip set), a macroprocessor, and/or generally any device for executing software instructions.

The memory component 284 can include any one or combination of volatile memory elements (e.g., random access memory (RAM, such as DRAM, SRAM, SDRAM, etc.)) and/or nonvolatile memory elements (e.g., ROM, hard drive, tape, CDROM, etc.). Moreover, the memory component 284 may incorporate electronic, magnetic, optical, and/or other types of storage media. One should note that the memory component 284 can have a distributed architecture (where various components are situated remote from one another), but can be accessed by the processor 282.

The software in the memory component 284 may include one or more separate programs, which may include an ordered listing of executable instructions for implementing logical functions. In the example of FIG. 2, the software in the memory component 284 may include an RPC application 288, as well as one or more other applications 299, which may or may not include other RPC applications. Additionally included is an operating system 286. The operating system 286 may be configured to control the execution of other computer programs and provides scheduling, input-output control, file and data management, memory management, and communication control and related services. The RPC application 288 may be configured to facilitate perform one or more actions, as discussed in more detail below.

A system component and/or module embodied as software may also be construed as a source program, executable program (object code), script, or any other entity comprising a set of instructions to be performed. When constructed as a source program, the program is translated via a compiler, assembler, interpreter, or the like, which may or may not be included within the memory component 284, so as to operate properly in connection with the operating system 286.

The input/output devices that may be coupled to the system I/O interface(s) 296 may include input devices, for example but not limited to, a keyboard, mouse, scanner, touch screen, microphone, etc. Further, the input/output devices may also include output devices, for example but not limited to, a printer, display, speaker, etc. Further, the input/output devices may further include devices that communicate both as inputs and outputs, for instance but not limited to, a modulator/demodulator (modem; for accessing another device, system, or network), a radio frequency (RF) or other transceiver, a telephonic interface, a bridge, a router, etc.

Additionally included are one or more of the network interfaces 298 for facilitating communication with one or more other devices. More specifically, network interface 298 may include any component configured to facilitate a connection with another device. While in some embodiments, among others, the client device 102 can include the network interface 298 that includes a personal computer memory card international association (PCMCIA) card (also abbreviated as “PC card”) for receiving a wireless network card, this is a nonlimiting example. Other configurations can include the communications hardware within the client device 102, such that a wireless network card is unnecessary for communicating wirelessly. Similarly, other embodiments include the network interfaces 298 for communicating via a wired connection. Such interfaces may be configured with universal serial bus (USB) interfaces, serial ports, and/or other interfaces.

If the client device 102 includes a personal computer, workstation, or the like, the software in the memory 284 may further include a basic input output system (BIOS) (omitted for simplicity). The BIOS is a set of software routines that initialize and test hardware at startup, start the operating system 286, and support the transfer of data among the hardware devices. The BIOS is stored in ROM so that the BIOS can be executed when the client device 102 is activated.

When the client device 102 is in operation, the processor 282 may be configured to execute software stored within the memory component 284, to communicate data to and from the memory component 284, and to generally control operations of the client device 102 pursuant to the software. Software in the memory component 284, in whole or in part, may be read by the processor 282, perhaps buffered within the processor 282, and then executed.

One should note that while the description with respect to FIG. 2 includes the client device 102 as a single component, this is a nonlimiting example. More specifically, in at least one embodiment, the client device 102 can include a plurality of servers, personal computers, telephones, and/or other devices. Similarly, while the description of FIG. 2 describes the client device 102 as a personal computer, this is also a nonlimiting example. More specifically, depending on the particular exemplary embodiment, other components, such as the servers 106 and/or the access point 110 may include similar elements and/or logic.

Additionally, while the RPC application 288 is illustrated in FIG. 2 as including a single software component, this is also a nonlimiting example. In at least one embodiment, the RPC application 288 may include one or more components, embodied in software, hardware, and/or firmware. Additionally, while the RPC application is depicted as residing on a single device, such as client device 102, the RPC application may include one or more components residing on one or more different devices.

In operation, RPC is a powerful technique for constructing distributed, client-server based applications. RPC configurations may be based on extending the notion of conventional or local procedure calling, so that the called procedure need not exist in the same address space as the calling procedure. The two processes might be on the same system, or they might be on different systems with a network connecting them. RPC specifically supports network applications. Transport Independent remote procedure call (TI-RPC) may be configured to run on available networking mechanisms such as transmission control protocol/internet protocol (TCP/IP). RPC services may be supported on both connection-oriented and datagram transports. The selection of the transport may depend on the requirements of the application.

In a computing device, such as client device 102, ports 1 through 1023, as a default, may be intended for systems services used by programs having super user privileges. As such, these ports may be referred to as reserved ports. Most of the RPC applications (e.g., network information service (NIS)) and kernel RPC threads that run in secure mode on UDP transport for asynchronous transactions may use reserved ports for security reasons. Since the number of reserved ports may be less than 1024, very often the client device 102 may run out of available reserved UDP ports during RPC transactions that exceed 1024 transactions at a time.

As discussed above, embodiments included herein may be configured to reuse client handles, in effect, reuse reserved ports used by RPC applications using a one-to-many remapping of client handles or reserved ports. In at least one embodiment, this may be achieved by m-to-n mapping between the remote clients and the RPC client handles. That is, applications may have a pool of RPC client handles (bound to reserved ports) from which to choose. For contacting a remote client, one or more client handles from that pool may be chosen. In such a scenario, there is a possibility for the transport address information to be changed in the client handle.

A virtual sockets solution may be utilized to handle such scenarios. In such a configuration, a virtual socket may be created on first response to a connection request by application. A first real socket with a unique port may be created for the application. When a second application establishes a new connection, a second real socket may be created with a different port, but mapping to the same virtual socket. This is a mechanism of having a single virtual socket for an application, but internally having multiple ephemeral ports.

As a nonlimiting example, referring again to the drawings, FIG. 3 depicts a block diagram, illustrating an exemplary embodiment of a client device 102 that may be configured to communicate with one or more hosts 102, such as in the network configuration from FIG. 1. As illustrated in the nonlimiting example of FIG. 3, the RPC application 288 may be coupled to a plurality of remote hosts 302 (which may be part of a remote client device 102), such as host-0 302a, host-1023 302b, and host-1024 302c via a plurality of ports 304a, 304b, 304c. The RPC client handles pool 306 may be configured to have a plurality (in this nonlimiting example, two) client handles, such as handle-A 306a and handle-B 306b. When the RPC application 288 attempts to contact the host-1 302a, the RPC application 288 may pick up handle-0 306a and fill handle-0 306a with the address of host-0 302a. By doing this, a mapping may be established between host-0 302a and handle-0 306a. Similarly, another mapping may be established between host-1023 302b and handle-1023 306b. If RPC application 288 attempts to contact host-1024 302c, there may be no extra client handles (ports 304, because each client handle may correspond to a unique port) in the pool.

FIG. 4 depicts a block diagram of an exemplary embodiment of an RPC application 288, utilizing a pool of network ports 404, similar to the diagram from FIG. 3. As illustrated in the nonlimiting example of FIG. 4, the RPC application 288 may be coupled to one or more hosts 402a, 402b, 402c via one or more ports 404x and 404y. However, in this nonlimiting example, the RPC application 288 may be configured to utilize handle-A 406a and handle-B 406b in a manner to communicate with the hosts 402a-402c without a 1-to-1 mapping of ports 404 to hosts 402. In this nonlimiting example, the RPC application 288 may be configured to utilize a least recently used (LRU) queue 407. The LRU queue 407 may be configured to determine which handle 406 has been least recently used, such that when a new mapping is desired, the RPC application can utilize the least recently used handle to facilitate the new mapping.

FIG. 5 depicts a block diagram of an exemplary embodiment of an RPC application 288 utilizing a hash table 509 to communicate with one or more hosts 502, similar to the diagram from FIG. 4. As illustrated in the nonlimiting example of FIG. 5, the RPC application 288 may be configured to communicate with hosts 502a, 502b, 502c via ports 504x, 504y. More specifically, the RPC application 288 may include handle-A 506a and handle-B 506b. Additionally, the RPC application 288 may include an LRU queue 507, as well as a hash table 509.

In operation, when the RPC application 288 attempts to contact a host 502 at a remote client device 102, the RPC application 288 may determine, via the hash table 590, whether there is an existing mapping between that remote client's name and an RPC client handle 506. If such a mapping exists, then the RPC application 288 may pick up the mapped client handle (e.g., handle-A 506a) and use the mapped client handle for making RPC calls. If there exists no such mapping, then the RPC application 288 may determine a client handle 506 to use, and pick up that client handle 506 to establish a new mapping (by filling the transport address of the given remote host 502).

For picking up a client handle 506, a least recently used (LRU) determination (e.g., via LRU queue 507) may be used. That is, the least recently used client handle 506 may be picked for establishing a new mapping description. A nonlimiting example of a LRU algorithm may include the following:

struct rp_clnt_handle {
CLIENT *clnt; /* Client handle bound to a resv. port */
struct cache *owner; /* cache structure associated with this handle */
int prognum; /* Prog. number set in this client handle */
int versnum; /* Vers. number set in this client handle */
struct rp_clnt_handle *next; /* Next handle in the LRU list */
struct rp_clnt_handle *prev; /* Previous handle in the LRU list */
};

The structure ‘struct rp_clnt_handle’ may be added and may be configured to store the client handle, which is bound to a reserved port. ‘Struct cache’ may be modified to include a new member which is a pointer to ‘struct rp_clnt_handle’. As per this design, a queue (based on LRU technique) of ‘struct rp_clnt_handle’ may be configured to handle is maintained. In the queue, one or more elements (struct rp_clnt_handle) may be mapped to a cache structure (‘struct cache’).

struct rp_clnt_handle *rp_handle_head->Points to the head of the LRU queue.

struct rp_clnt_handle *rp_handle_tail->Points to the tail of the LRU queue.

One should note that a cache element (struct cache) may be a handle to contact a remote client. As there may be a limited number of reserved ports, the elements in the LRU queue 407 (rp_handle_head) may be shared among all the cache elements. By default, lockd may have a limited number of reserved ports (e.g., 10). As such, in at least one embodiment, there can be only a limited number (e.g., 10) rp_clnt_handle elements in the LRU queue 407. Each element in the LRU queue 407 may have a client handle 406 that is bound to a reserved port. At any given time, there may be a limited number (e.g., 10) cache elements that have their mapping with the available rp_clnt_handle elements. The rest of the cache elements may not have any mapping. That is, cache->rp_clnt_h points to NULL. If there exists a mapping between a cache structure and a ‘rp_clnt_handle’ element, then cache->rp_clnt_h will be pointing to a ‘rp_clnt_handle’ element in the LRU queue.

One should also note that, while an LRU computation may be used, other techniques for determining a handle 506 may be utilized. More specifically, an average use calculation may be used, and/or other computations.

One should also note that some embodiments may be configured to not use reserved ports. Such configurations may make use of ephemeral ports for asynchronous RPC transactions. Further some embodiments may be configured to switch to other modes of transport like TCP, etc. Other configurations are also contemplated.

FIG. 6 depicts a flowchart 630 illustrating an exemplary embodiment of a process that may be utilized for communicating with at least one host 502, such as in the diagram from FIG. 5. As illustrated in the nonlimiting example of FIG. 6, the RPC application 288 may access the hash table 509 to determine whether a mapping exists between a host 502 and an RPC client handle 506 (block 632). A determination can be made whether a current mapping exists between the host 502 and a client handle 506 (block 634). If a mapping exists, the RPC application 288 can pick up the mapped client handle 506 and utilize this handle 506 for making RPC calls (block 636). If, on the other hand, no mapping exists, the RPC application 288 can determine a different client handle by, for example, utilizing an LRU queue 507 (block 638) The RPC application 388 can establish a new mapping for the different client handle 506 by filling the transport address of the given remote host 502 (block 640).

FIG. 7 depicts a flowchart 730 of an exemplary embodiment of a process that may be utilized for determining whether a mapping exists with a remote host 502, similar to the flowchart from FIG. 6. More specifically, as illustrated in the nonlimiting example of FIG. 7, a request may be received to communicate with a remote host 502 (block 732). The request may be received via a user accessing an RPC application 288, however this is not a requirement. A hash table 509 may then be accessed to determine whether a mapping exists with the host 502 (block 734). A determination can be made whether the mapping exists (block 736). If the mapping exists, the mapped client handle 506 can be picked up and utilized for making RPC calls (block 738). If, on the other hand, a mapping does not currently exist for the host 502, an LRU queue 507 can be utilized to determine a different client handle 506 to utilized (block 740). A new mapping can be established for the different client handle 506 (block 742).

The embodiments disclosed herein can be implemented in hardware, software, firmware, or a combination thereof. At least one embodiment disclosed herein may be implemented in software and/or firmware that is stored in a memory and that is executed by a suitable instruction execution system. If implemented in hardware, one or more of the embodiments disclosed herein can be implemented with any or a combination of the following technologies: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

One should note that the flowcharts included herein show the architecture, functionality, and operation of a possible implementation of software. In this regard, each block can be interpreted to represent a module, segment, or portion of code, which comprises one or more executable instructions for implementing the specified logical function(s). It should also be noted that in some alternative implementations, the functions noted in the blocks may occur out of the order and/or not at all. For example, two blocks shown in succession may in fact be executed substantially concurrently or the blocks may sometimes be executed in the reverse order, depending upon the functionality involved.

One should note that any of the programs listed herein, which can include an ordered listing of executable instructions for implementing logical functions, can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, or transport the program for use by or in connection with the instruction execution system, apparatus, or device. The computer readable medium can be, for example but not limited to, an electronic, magnetic, optical, electromagnetic, infrared, or semiconductor system, apparatus, or device. More specific examples (a nonexhaustive list) of the computer-readable medium could include an electrical connection (electronic) having one or more wires, a portable computer diskette (magnetic), a random access memory (RAM) (electronic), a read-only memory (ROM) (electronic), an erasable programmable read-only memory (EPROM or Flash memory) (electronic), an optical fiber (optical), and a portable compact disc read-only memory (CDROM) (optical). In addition, the scope of the certain embodiments of this disclosure can include embodying the functionality described in logic embodied in hardware or software-configured mediums.

One should also note that conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more particular embodiments or that one or more particular embodiments necessarily include logic for deciding, with or without user input or prompting, whether these features, elements and/or steps are included or are to be performed in any particular embodiment.

It should be emphasized that the above-described embodiments are merely possible examples of implementations, merely set forth for a clear understanding of the principles of this disclosure. Many variations and modifications may be made to the above-described embodiment(s) without departing substantially from the spirit and principles of the disclosure. All such modifications and variations are intended to be included herein within the scope of this disclosure.

Therefore, at least the following is claimed:

1. A method, comprising:
receiving (732) a request to communicate with a host (502);
determining (736) whether a mapping exists between the host (502) and a first remote procedure call (RPC) client handle (506); and
in response to determining that a mapping does not exist between the host and the first RPC client handle, determining (740) a second RPC client handle (506) to establish a mapping, the established mapping facilitating RPC communication with the host.

2. The method of claim 1, further comprising establishing the mapping (742) between the second RPC handle (506) and the host (502).

3. The method of claim 2, further comprising sending data to the host (502) via the established mapping.

4. The method of claim 1, wherein determining whether a mapping exists includes accessing a hash table (509).

5. The method of claim 1, wherein determining a second RPC handle (506) to establish mapping includes determining a least recently used RPC handle (740).

6. The method of claim 5, wherein determining a least recently used RPC handle includes utilizing (740) a least recently used (LRU) queue (507).

7. The method of claim 1, further comprising, in response to determining that a mapping exists, determining the RPC handle that is mapped to the host and utilizing mapping to send data to the host.

8. A computer readable medium, comprising:
receiving logic (288) configured to receive (732) a request to communicate with a host (502);
first determining logic (288) configured to determine (736) whether a mapping exists between the host (502) and a first remote procedure call (RPC) client handle (506); and
second determining logic (288) configured, in response to determining that a mapping does not exist between the host (502) and the first RPC client handle (506), to determine a second RPC client handle (506) to establish a mapping, the established mapping facilitating RPC communication with the host (502).

9. The computer readable medium of claim 8, further comprising establishing logic (288) configured to establish the mapping between the second RPC handle (506) and the host (502).

10. The computer readable medium of claim 9, further comprising sending logic (288) configured to send data to the host (502) via the established mapping.

11. The computer readable medium of claim 8, wherein determining whether a mapping exists includes accessing a hash table (509).

12. The computer readable medium of claim 8, wherein determining a second RPC handle (506) to establish mapping includes determining a least recently used RPC handle.

13. The computer readable medium of claim 12, wherein determining a least recently used RPC handle (506) includes utilizing a least recently used (LRU) queue (507).

14. The computer readable medium of claim 8, further comprising third determining logic (288) configured, in response to determining that a mapping exists, to determine the RPC handle (506) that is mapped to the host and utilize mapping to send data to the host.

15. A system, comprising:
means for receiving a request to communicate with a host (502);
means for determining whether a mapping exists between the host (502) and a first remote procedure call (RPC) client handle (506); and
means for, in response to determining that a mapping does not exist between the host and the first RPC client handle (506), determining a second RPC client handle (506) to establish a mapping, the established mapping facilitating RPC communication with the host (502).

16. The system of claim 15, further comprising means for establishing the mapping between the second RPC handle (506) and the host (502).

17. The system of claim 16, further comprising means for sending data to the host (502) via the established mapping.

18. The system of claim 15, wherein determining whether a mapping exists includes accessing a hash table (509).

19. The system of claim 15, wherein determining a second RPC handle (506) to establish mapping includes determining a least recently used RPC handle.

20. The system of claim 19, wherein determining a least recently used RPC handle includes utilizing a least recently used (LRU) queue (507).
